(19) United States
(12) Patent Application Publication
(10) Pub. No.: US 2007/0034390 A1
(43) Pub. Date: Feb. 15, 2007

(54) AEROSOL FIRE EXTINGUISHER

(75) Inventor: William Vegso, Charlotte, NC (US)

Correspondence Address: ADAMS EVANS P.A., 301 SOUTH TRYON STREET, SUITE 2180, TWO WACHOVIA CENTER, CHARLOTTE, NC, 28282-1991, US

(73) Assignee: BUCKEYE FIRE EQUIPMENT COMPANY, Kings Mountain, NC (US)

(21) Appl. No.: 11/463,997

(22) Filed: Aug. 11, 2006

Related U.S. Application Data
(60) Provisional application No. 60/708,164, filed on Aug. 15, 2005.

(51) Int. Cl. A62C 11/00; A62C 13/62; A62C 13/00

(52) U.S. Cl. 169/30; 169/71; 169/72

(57) ABSTRACT

A convenient, lightweight aerosol fire extinguisher system. The aerosol fire extinguisher system includes a fire extinguisher and a bracket. The extinguisher contains a pressurized fire extinguishing agent, and includes a depressable nozzle positioned at a top of the extinguisher for releasing the agent. The bracket supports the extinguisher in a stowed position, and includes a base for being releasably attached to a supporting structure, and a holder for securing the extinguisher to the bracket and allowing for easy removal in the event of a fire by pulling the extinguisher out of the bracket. The bracket further includes an attachment for releasably securing the bracket to the supporting structure.

### CROSS-REFERENCE TO RELATED APPLICATIONS

This application claims the benefit of Provisional Application No. 60/708,164 filed on Aug. 15, 2005.

### TECHNICAL FIELD AND BACKGROUND OF THE INVENTION

This invention relates to an aerosol fire extinguisher. The aerosol fire extinguisher expels a gentle spray of a chemical agent specifically designed for use on a grease fire. The aerosol fire extinguisher is a compact, lightweight alternative to a conventional fire extinguisher. It is relatively inexpensive to manufacture; therefore, more economical to use than a conventional fire extinguisher on a grease fire.

Conventional fire extinguishers are sturdy metal cylinders that are relatively heavy, bulky, and hard to maneuver. These fire extinguishers are activated when a lever on top of the cylinder is depressed, expelling a chemical agent at a high pressure. The force with which the chemical agent is discharged can cause the grease and other burning material to be flushed from their relatively confined area, causing the fire to spread. Therefore, a conventional fire extinguisher can be hazardous when used on grease fires.

In addition, many conventional fire extinguishers contain a dry chemical agent that is intended to smother a fire. However, these chemical agents are not specifically designed to smother a grease fire. The chemical agent does not lower the grease below the autoignition temperature, and, as a result, this type of conventional fire extinguisher is ineffective on grease fires.

This invention provides a convenient, lightweight alternative to a conventional fire extinguisher. The aerosol fire extinguisher includes a specifically designed chemical agent to extinguish a grease fire. The chemical agent is expelled from the aerosol fire extinguisher in a fine mist to prevent spreading the fire.

### SUMMARY OF THE INVENTION

Therefore, it is an object of the invention to provide a fire extinguisher that is specifically designed to effectively extinguish a grease fire.

It is another object of the invention to provide a fire extinguisher that is easily stored, used, and transported.

It is another object of the invention to provide a fire extinguisher with a gentle spray that will extinguish a grease fire safely.

These and other objects of the present invention are achieved in the preferred embodiments disclosed below by providing an aerosol fire extinguisher system. The aerosol fire extinguisher system includes a fire extinguisher and a bracket. The extinguisher contains a pressurized fire extinguishing agent, and includes a depressable nozzle positioned at a top of the extinguisherfor releasing the agent. The bracket supports the extinguisher in a stowed position, and includes a base for being releasably attached to a supporting structure, a holder for securing the extinguisher to the bracket and allowing easy removal in the event of a fire by pulling the extinguisher out of the bracket, and an attachment for releasably securing the bracket to the supporting structure.

According to another preferred embodiment of the invention, and further including a propellant in the extinguisher for dispensing the agent through the nozzle.

According to another preferred embodiment of the invention, the propellant is nitrogen.

According to another preferred embodiment of the invention, the propellant is air.

According to another preferred embodiment of the invention, the extinguisher has a volume of about 300 ml to about 500 ml.

According to another preferred embodiment of the invention, the extinguisher has a full discharge time of about 3 minutes.

According to another preferred embodiment of the invention, the agent comprises a mixture of a chemical agent and deionized water.

According to another preferred embodiment of the invention, the chemical agent is selected from the group consisting of potassium carbonate, potassium acetate, and potassium citrate.

According to another preferred embodiment of the invention, the chemical agent comprises about 10 wt. % to about 40 wt. % of the total weight of the agent.

According to another preferred embodiment of the invention, the nozzle produces a fine spray when depressed to prevent spreading of a fire.

According to another preferred embodiment of the invention, the nozzle projects the agent at an angle of about 30° to allow a user to stand about three feet to about five feet away from the fire.

According to another preferred embodiment of the invention, an aerosol fire extinguisher system including an aerosol can having a pressurized fire extinguishing agent contained therein, and a bracket for supporting the can in a stowed position. The can includes a depressable nozzle operably connected to a top of the can for releasing the agent. The bracket includes a base for being releasably secured to a supporting structure, at least one curved projection extending outwardly from the base for securing the can to the bracket and allowing easy removal of the can by pulling the can out of the bracket, and a magnet positioned in the base for releasably securing the support and the can to the supporting structure.

According to another preferred embodiment of the invention, the nozzle produces a uniform spray when depressed to prevent spreading of a fire.

According to another preferred embodiment of the invention, the projection has a radius of curvature slightly greater than a radius of curvature of the can to allow the can to be slid into the bracket between the at least one projection and the base.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is a part sectional view of the fire extinguisher system; and

FIG. 2 is a perspective view of the clip and magnetic support.

### DESCRIPTION OF THE PREFERRED EMBODIMENTS AND BEST MODE

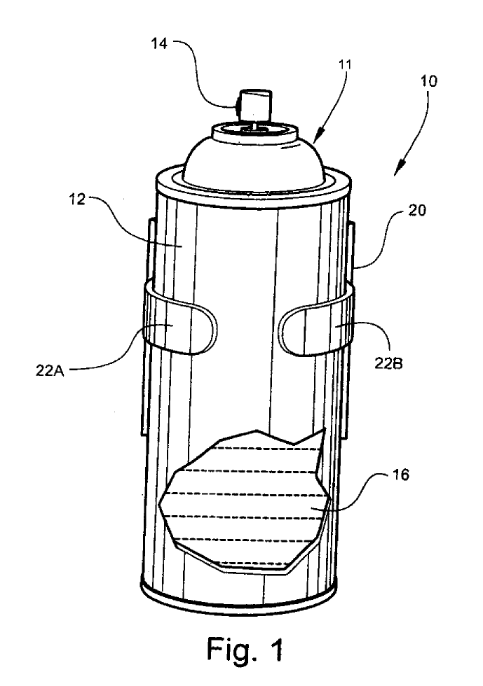

Referring now specifically to the drawings, an aerosol fire extinguishing system according to the present invention is illustrated in FIG. 1 and is shown generally at reference numeral 10. The aerosol fire extinguishing system 10 includes an aerosol fire extinguisher 11, in the form of an aerosol can 12, and a bracket 18 for holding the extinguisher 11. The aerosol can 12 includes a spray nozzle 14 and an extinguishing agent 16 contained therein. The can 12 is a conventional aerosol can capable of retaining its contents under pressure. The can 12 has a volume of about 300 ml to about 500 ml, and a full discharge time of about 3 minutes. The spray nozzle 14 is a conventional nozzle such as that found on an aerosol can.

The can 12 is filled with a fluent, liquid extinguishing agent 16, such as potassium carbonate, potassium acetate, and/or potassium citrate, and deionized water. The extinguishing agent 16 is present in the amount of about 10 wt. % to about 40 wt. % of the total weight of the extinguishing agent 16 and deionized water. Preferably, the extinguishing agent 16 is present in the amount of 10 wt. %.

A propellent, such as air or dry nitrogen, is used to dispense the extinguishing agent 16. During use of the aerosol fire extinguisher 11, the extinguishing agent is released in a fine spray from the can 12 when the spray nozzle 14 is depressed. The extinguishing agent 16 is projected at a 30° angle allowing the user to stand about three to about five feet away from the fire, while safely and effectively using the aerosol fire extinguisher 11. Throughout the life of the fire extinguisher 11, the propellant continuously expels essentially all of the extinguishing agent 16 from the can 12, while keeping the spray uniform.

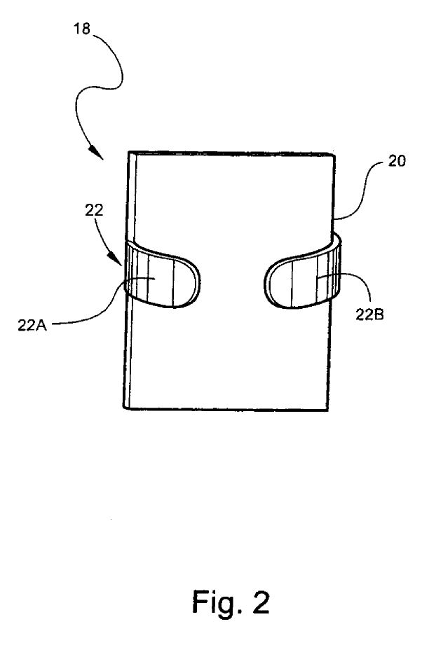

Referring to FIG. 2, the bracket 18 includes a base 20 and a holder 22. As illustrated, the holder 22 includes two spaced-apart, curved fingers 22A and 22B extending outwardly from the base 20. However, it should be appreciated that the holder 22 may be of any structure or means that permits the bracket 18 to hold the can 12 securely. For example, the holder 20 may be a magnet, a single finger extending outwardly and around a substantial portion of the can 12, or a cup-type holder for receiving the can 12 therein.

The fingers 22A, 22B have a radius of curvature slightly greater than the radius of curvature of the can 12. The can 12 can be easily inserted into the bracket 18 by sliding the can 12 between the base 20 and the fingers 22A, 22B. In case of an emergency, the can 12 is easily dislodged by simply sliding or pulling the can away from the bracket 18.

The base 20 allows the bracket 18 to be attached to a supporting surface. The base 20 may be attached to the supporting surface by an adhesive, magnet, fastener, or any other suitable attachment. As illustrated, the base 20 is magnetic (the base may itself be a magnet or a magnet may be positioned in or on the base 20) to allow the bracket 18 to be releasably secured to an appliance such as a refrigerator or stove. These surfaces serve as a convenient and readily accessible location to store the extinguisher 10 until needed to extinguish a grease or small kitchen fire.

An improved fire extinguisher and fire extinguisher system is described above. Various details of the invention may be changed without departing from its scope. Furthermore, the foregoing description of the preferred embodiment of the invention and the best mode of practicing the invention are provided for the purpose of illustration only and not for the purpose of limitation.

I claim:

1. An aerosol fire extinguisher system, comprising:
(a) a fire extinguisher for containing a pressurized fire extinguishing agent, the fire extinguisher having a depressable nozzle positioned at a top of the fire extinguisher for releasing the agent; and
(b) a bracket for supporting the fire extinguisher in a stowed position, including:
(i) a base for being releasably attached to a supporting structure;
(ii) a holder for securing the fire extinguisher to the bracket and allowing easy removal of the fire extinguisher in the event of a fire by pulling the fire extinguisher out of the bracket; and
(iii) an attachment for releasably securing the bracket to the supporting structure.

2. The aerosol fire extinguisher system according to claim 1, and further including a fire extinguishing agent contained in the fire extinguisher.

3. The aerosol fire extinguisher system according to claim 2, and further including a propellant in the fire extinguisher for dispensing the agent through the nozzle.

4. The aerosol fire extinguisher system according to claim 3, wherein the propellant is nitrogen.

5. The aerosol fire extinguisher system according to claim 3, wherein the propellant is air.

6. The aerosol fire extinguisher system according to claim 1, wherein the fire extinguisher has a volume of about 300 ml to about 500 ml.

7. The aerosol fire extinguisher system according to claim 1, wherein the fire extinguisher has a full discharge time of about 3 minutes.

8. The aerosol fire extinguisher system according to claim 2, wherein the agent comprises a mixture of a chemical agent and deionized water.

9. The aerosol fire extinguisher system according to claim 8, wherein the chemical agent is selected from the group consisting of potassium carbonate, potassium acetate, and potassium citrate.

10. The aerosol fire extinguisher system according to claim 8, wherein the chemical agent comprises about 10 wt. % to about 40 wt. % of the total weight of the agent.

11. The aerosol fire extinguisher system according to claim 1, wherein the nozzle produces a fine spray when depressed to prevent spreading of a fire.

12. The aerosol fire extinguisher system according to claim 1, wherein the nozzle projects the agent at an angle of about 30° to allow a user to stand about three feet to about five feet away from the fire.

13. An aerosol fire extinguisher system, comprising:
(a) an aerosol can having a pressurized fire extinguishing agent contained therein, the can having a depressable nozzle positioned at a top of the can for releasing the agent; and
(b) a bracket for supporting the container in a stowed position, including:
(i) a base for being releasably attached to a supporting structure;
(ii) at least one curved projection extending outwardly from the base for securing the can to the bracket and allowing easy removal of the can by pulling the can out of the bracket; and
(iii) a magnet positioned in the base for releasably securing the bracket to the supporting structure.

14. The aerosol fire extinguisher system according to claim 13, and further including a propellant contained in the can to dispense the agent through the nozzle.

15. The aerosol fire extinguisher system according to claim 13, wherein the extinguisher has a full discharge time of about 3 minutes.

16. The aerosol fire extinguisher system according to claim 13, wherein the agent comprises a mixture of a chemical agent and deionized water.

17. The aerosol fire extinguisher system according to claim 16, wherein the chemical agent comprises about 10 wt. % to about 40 wt. % of the total weight of the agent.

18. The aerosol fire extinguisher system according to claim 13, wherein the nozzle produces a uniform spray when depressed to prevent spreading of a fire.

19. The aerosol fire extinguisher system according to claim 13, wherein the nozzle projects the agent at an angle of about 30° to allow a user to stand about three feet to about five feet away from the fire.

20. The aerosol fire extinguisher system according to claim 13, wherein the projection has a radius of curvature slightly greater than a radius of curvature of the can to allow the can to be slid into the bracket between the at least one projection and the base.

21. The aerosol fire extinguisher system according to claim 13, wherein the bracket includes a pair of spaced-apart curved projections extending outwardly from the base.
